(19) United States
(12) Patent Application Publication
(10) Pub. No.: US 2020/0099962 A1
(43) Pub. Date: Mar. 26, 2020

(54) Shared Live Audio

(71) Applicant: Facebook, Inc., Menlo Park, CA (US)

(72) Inventors: Maher Afif Saba, Seattle, WA (US); Amit Puntambekar, Fremont, CA (US)

(21) Appl. No.: 16/137,449

(22) Filed: Sep. 20, 2018

(51) Int. Cl. H04N 21/233; G06F 3/16; H04L 29/06; H04N 21/2187

(52) U.S. Cl. CPC H04N 21/2335; H04N 21/2187; H04L 65/601; G06F 3/165

(57) ABSTRACT

In one embodiment, a method includes streaming digital content for presentation by at least two user computing devices (e.g., phones, laptops, virtual reality headsets, TVs, etc.). Audio content, generated by a user of one of the user computing devices, is recorded and mixed with the native audio content from the streamed digital content, generating remixed digital content. The recorded and native audio content are mixed based on a predetermined ratio of recorded audio content and native audio content. The remixed digital content is then streamed for presentation for each other user of the user computing devices.

### TECHNICAL FIELD

This disclosure generally relates to consuming digital content.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

A user of a mobile computing device may use the computing device to consume digital content (e.g., photos, videos, games, etc.). When two or more users of computing devices are together in the same physical space, a first user may use his or her computing device to allow one or more of the other users to consume digital content. Similarly, one or more of the other users may utilize their respective devices to allow the first user or any number of the other users to consume content from the respective devices. A user of a social-networking system may also utilize the social-networking system and a computing device to share digital content through the social-networking system with one or more other users, so that those users may consume the digital content.

### SUMMARY OF PARTICULAR EMBODIMENTS

This disclosure generally relates to allowing multiple users in different real locations to engage in auditory conversations while consuming the same digital content. The invention may begin when two or more users begin consuming the same digital content. Once joined in a conversation, the two or more users may engage in a discussion presumably but not necessarily related to the digital content. As each user speaks, creating audio content, the content may be fed to one or more other users as commentary on the digital content. The commentary may be fed back into the stream, mixed with the native audio, and distributed back to the other users. In some embodiments, this mixing of commentary with the native audio from the digital content may simulate a live viewing experience as if the two or more users were at the same live sporting event together, or in the same room watching a political debate together, as examples.

In some embodiments, users may have the option to select which other users they engage in conversation with. This selection may include selecting one or more users or groups of users to converse with. This selection process may be done automatically, based on a relationship coefficient, or it may be done manually, based on the selected preferences of a user. In some embodiments, a user may be able to select the degree to which they engage in conversation with one or more users. In other words, a first user may select a second user as a primary conversation partner. The first user may also select a third and a fourth user as secondary conversation partners. In some embodiments, the system may then mix the audio from each of the conversation partners, plus the native audio from the digital content, to reflect the degree with which the first user has decided to engage the other users (e.g., 40% of the audio feed may be native audio from the digital content, 40% may be from the one primary conversation partner, and 20% may be from the two secondary conversation partners). This mixing may be automatically or manually adjusted in real time based on each user's conversation contributions and the preferences of the user for whom the mixing is being adjusted.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example embodiment in which two users consume the same digital content while simultaneously engaging in a separate conversation about the digital content (prior art).

FIG. 2 illustrates an example embodiment in which two users consume the same digital content and their conversation about the digital content is mixed with the audio content that is native to the digital content.

FIG. 3 illustrates an example method for mixing audio content from multiple sources.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

Embodiments of this invention are related to allowing multiple users in different real locations to engage in auditory conversations while consuming the same digital content. Some embodiments may begin when two or more users begin consuming the same digital content. In some embodiments, the users may be prompted that other users are consuming the same digital content. In some embodiments a first user may automatically be connected to another user or group of users in an audio conversation after the first user begins consuming digital content that is also being consumed by the other user or group of users. In other embodiments, each user may need to manually elect to join in an audio conversation with one or more other users, even if all users are consuming the same digital content. Once joined in a conversation, the two or more users may engage in a discussion that is presumably, but not necessarily, related to the digital content. As each user speaks, creating audio content, the content may be fed to one or more other users as commentary on the digital content. The commentary may be fed back into the stream, mixed with the native audio, and distributed back to the other users. In some embodiments, this mixing of commentary with the native audio from the digital content may simulate a live viewing experience as if the two or more users were at the same live sporting event together, or in the same room watching a political debate together, as examples.

It should be understood that digital content may comprise any digital content that may be presented to two or more users of user computing devices. As such, digital content may comprise audio or video content. Similarly, digital content may comprise virtual or augmented reality, scent or touch based digital content, or any other digital content that can be presented to two or more users. A user computing device may comprise any computing device capable of presenting digital content to one or more users. Examples of a user computing device include a cellphone, TV, virtual reality headset, laptop computer, desktop computer, etc. Embodiments described below may describe users and user computing devices as corresponding at a 1:1 ratio, that is one user computing device for each one user. It should be understood that embodiments of the invention may include users and computing devices at other ratios, including two users for each of two or more user computing devices, a large group of users for each of two or more user computing devices, etc.

In some embodiments, users may have the option to select which other users they engage in conversation with. This selection may include selecting one or more users or groups of users to converse with. This selection process may be done automatically, based on a relationship coefficient, or it may be done manually. In some embodiments, the relationship coefficient may be manually set by a user or may be determined based on one or more other factors, including their relationship within a social network, conversation history, content preferences, or any number of additional factors. In some embodiments, the relationship coefficient may be based at least in part on a social-graph affinity. In some embodiments, the social-graph affinity, described in greater detail below, may represent the strength of a relationship or level of interest between particular objects associated with the online social network, such as users, concepts, content, actions, advertisements, other objects associated with the online social network, or any suitable combination thereof. In some embodiments, a relationship coefficient between any two users may vary based on any number of factors, including time of day, the type of digital content being consumed (e.g., if a user begins watching a sports game, that user may be automatically matched first with another friend who historically watches significant amounts of sports programming), or any number of additional factors. In some embodiments, the number of users in a conversation may be capped to foster greater intimacy of dialogue and to prevent users from excessively talking over one another.

In some embodiments, users may select from one or more viewing groups with which they may jointly consume digital content and engage in conversation with. In some embodiments, one or more users may be designated as a host and may have certain exclusive abilities to control the conversation or digital content. In other embodiments, all users may share control equally. In some embodiments, the host may be able to create a custom audio theme for a group. For example, for a particular group that is watching a live sports event, one or more hosts may create a custom theme for a group with background theme music related to the favorite team participating in the live sports event. In some embodiments the background theme music may be selected from a previously uploaded catalog and played at low volume while the native audio from the sports event is played at a higher volume. In some embodiments, the theme music, native audio, and conversation audio recorded in real time from the users in the group may all be mixed and streamed concurrently with the live sports event, as an example.

In some embodiments, a user may be able to select the degree to which they engage in conversation with one or more users. In other words, a first user may select a second user as a primary conversation partner. The first user may also select a third and a fourth user as secondary conversation partners. In some embodiments, the system may then mix the audio from each of the conversation partners, plus the native audio from the digital content, to reflect the degree with which the first user has decided to engage the other users (e.g., 40% of the audio feed may be native audio from the digital content, 40% may be from the one primary conversation partner, and 20% may be from the two secondary conversation partners). This mixing may be automatically or manually adjusted in real time based on each user's conversation contributions and the preferences of the user for whom the mixing is being adjusted.

In some embodiments the mixing of audio content may comprise mixing each individual audio source (e.g., native audio from the digital content, recorded audio from one or more users, or theme/background music) into one audio file, which may then be streamed as the audio content for a piece of digital content to one or more users. In other embodiments, each audio source may be streamed concurrently but separately to the one or more users.

In some embodiments, the digital content may be configured to be paused, such that two or more users can pause the content to discuss it as necessary. In some embodiments, particular sessions of digital content consumption may be labeled as “catch up” or “discussion” sessions with an intended purpose of catching up new viewers (e.g., new viewers to a TV series who are jumping in to the third season) or of providing an opportunity for discussion for fans of particular digital content. In other embodiments, particular sessions of digital content consumption may be labeled with other themes, including fans of a particular sport or sports team, fans of a particular show or movie franchise, players or fans of a particular video game, etc.

In some embodiments, any user may be able to control the volume and playback of the digital content. In other embodiments, each user may have individual volume control but no playback control, and in other embodiments, only a host may have control of the content. In some embodiments, a host may be selected randomly from among the users. In some embodiments a user may volunteer to be the host user. In other embodiments a user may be randomly selected to be the host only if no user volunteers to be the host user. In other embodiments, all present users may vote on a user to designate as the host user.

Some embodiments may begin with digital content being sent to a mixer. The mixer may then send the digital content to each of the users who has chosen to jointly consume the digital content. Any number of conversations pairs or groups may form between the users. Any one user may have multiple conversation pairs or groups. In some embodiments, a first user may choose to talk, generating audio content. The audio content may be fed back to the mixer and mixed with the native audio from the digital content and redistributed to one or more users who are in a conversation pair or group with the first user. In some embodiments mixing the native audio from the digital content with the recorded audio from the one or more users may comprise generating a single audio content file or a single digital content file to be streamed to the one or more users. The content may be mixed according to the preferences of each of the one or more users.

In some embodiments, as part of the mixing step, a validator may ensure that no user's audio content will reach another user before the relevant digital content has been played. As an illustrative example, if a first user has a slow connection, they may be several seconds behind a second user who has a faster connection. Without the validator, commentary from the second user could be mixed with an inappropriate portion of the digital content (e.g., a touchdown celebration song could be mixed in as a quarterback is only beginning to snap the ball). In some embodiments, the validator may prevent this, be tracking the digital content being presented to the second user at the time of the commentary, and pairing the commentary with the same portion of digital content as it is presented to the first user.

Embodiments that involve the mixing, validation, or streaming of digital content, or other computational steps, methods, or processes may be performed by a user computing device or by a server computing device. For example, native audio content and recorded audio content may be sent to a server computing device that may then mix the audio content and send audio or digital content back to the two or more user computing devices. Alternatively, native and recorded audio content may be sent to a single user computing device that may then mix the audio content and send it back to each other user computing device.

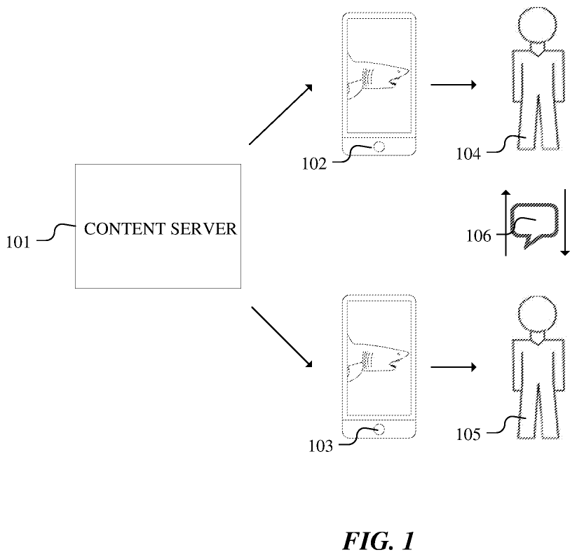

FIG. 1 illustrates an example embodiment in which two users consume the same digital content while simultaneously engaging in a separate conversation about the digital content. In some embodiments content server 101 may serve content to each of first user computing device 102 and second user computing device 103. In this example user computing devices 102 and 103 are cell phones, each of which is presenting the same digital content. In this example, the digital content is a scene from the movie “Jaws.” First user computing device 102 may correspond to a first user 104 and second user computing device 103 may correspond to a second user 105. First user 104 and second user 105 are maintaining a separate conversation related to the digital content, represented by chat bubble 106. Conversation 106 may be facilitated by way of some other communication application on the user computing devices 102 and 103 or it may be facilitated by some other means. For example, the users may each be watching the content on user computing devices 102 and 103 while maintain a conversation about the content on a separate pair of cellphones. Alternatively, the users may be watching the content on laptops but talking about it on the phone. Notably, the audio content from the conversation 106 is not mixed with the audio content that is native to the digital content. This may decrease the immersion of the experience of watching the content together or may result in each user having difficulty hearing either the native audio content from the digital content or the audio content from the conversation 106.

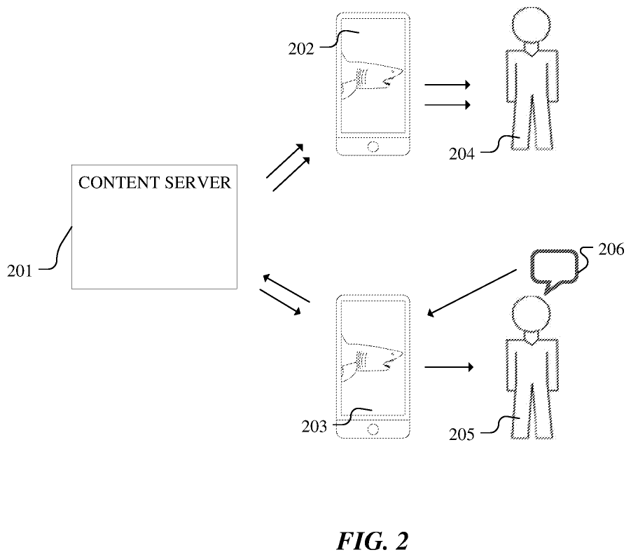

FIG. 2 illustrates an example embodiment in which two users consume the same digital content and their conversation about the digital content is mixed with the audio content that is native to the digital content. In this embodiment, content server 201 may still initially serve the same digital content to each of user computing devices 202 and 203. First user 204 may correspond to first user computing device 202 and second user 205 may correspond to second user computing device 203. In this embodiment, as second user 205 speaks, generating recorded audio content 206, the audio content is recorded by second user computing device 203. Second user computing device 203 then sends the recorded audio content 206 to content server 201. It should be understood that content server 201 is represented as a single server, but may be a user computing device, multiple server or user computing devices, or any number of other computing devices necessary to send, receive, and mix native and recorded audio content. Upon receiving recorded audio content 206, content server 201 mixes recorded audio content 206 with the native audio content and serves it back to first user computing device 202, to be presented to first user 204. FIG. 2 illustrates the example in which second user 205 is generating recorded audio content, but it should be understood that any combination of audio content, including audio content generated by first user 204, audio content generated by second user 205, audio content native to the digital content, audio content selected by any or some of the users (e.g., a song selected to be played in the background), or audio content from any number of additional users (e.g., a third user, a fourth user, etc.) may be mixed with the native audio content to produce remixed digital content which incorporates audio content from all of the audio content sources.

In some embodiments, the audio content from each of the audio content sources may be mixed according to a predetermined ratio. For example, first user 204 might select the ratio of recorded audio content 206 to native audio content that they would like to hear. As an example, if second user 205 is particularly knowledgeable about the digital content being presented, first user 204 may desire to hear recorded audio content 206 at a higher ratio than he might otherwise. Alternatively, if second user 205 is extremely annoying and won't stop talking during the movie, first user 204 may desire to hear less of second user 205. In some embodiments the ratio may be selected by each user. In other embodiments, the ratio may be learned over time based on individual or historical average user selections, based on a preset algorithm, based on the digital content type, or based on any additional number of factors. For example, if the digital content is suspenseful, dialog-based thriller, first user 204 may desire to hear very little of second user 205's recorded audio content 206. However if the digital content is a highly competitive sports event with little dialog or commentary, first user 204 may be more interested in bantering back and forth with second user 205. This mixing may be automatically or manually adjusted in real time based on each user's conversation contributions and the preferences of the user for whom the mixing is being adjusted.

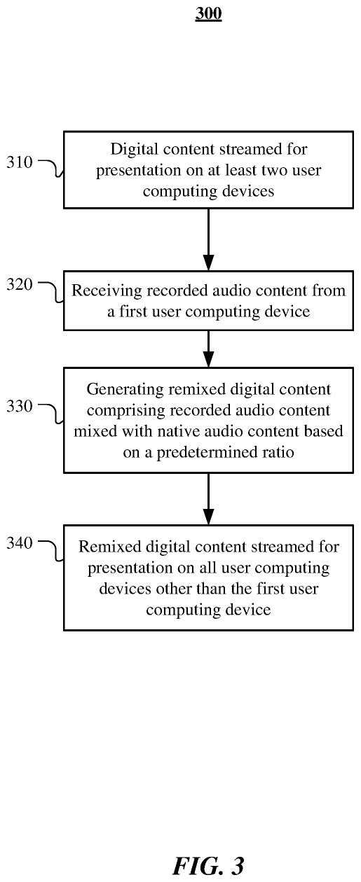

FIG. 3 illustrates an example method 300 for mixing audio content from multiple sources. The method may begin at step 310, where digital content may be streamed by a computing device to at least two user computing devices for presentation by the at least two user computing devices. At step 320, the computing device may receive recorded audio content from one or more of the two or more user computing devices. At step 330, the computing device may generate remixed digital content that includes the native audio content from the streamed digital content mixed with recorded audio content from the one or more user computing devices. The remixed digital content may mix the recorded audio content, the native audio content, and any other audio content source based on a predetermined ratio. The predetermined ratio may be based on any number of factors including the relationship between the users of the two or more user computing devices, user settings, or any number of additional factors. At step 340, the computing device may stream the remixed digital content to at least one of the user computing devices for presentation by the at least one user computing devices. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for mixing audio content from multiple sources including the particular steps of the method of FIG. 3, this disclosure contemplates any suitable method for mixing audio content from multiple sources including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

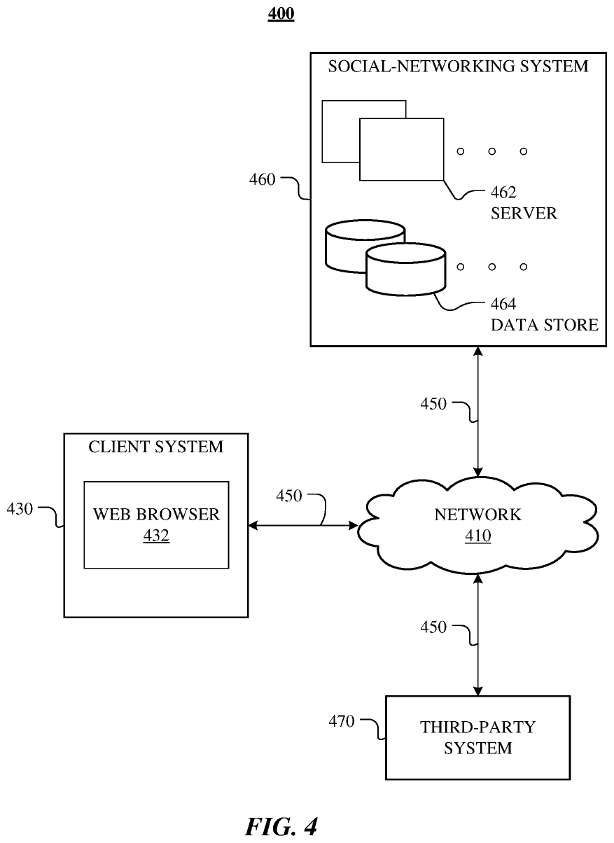

FIG. 4 illustrates an example network environment 400 associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 462, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

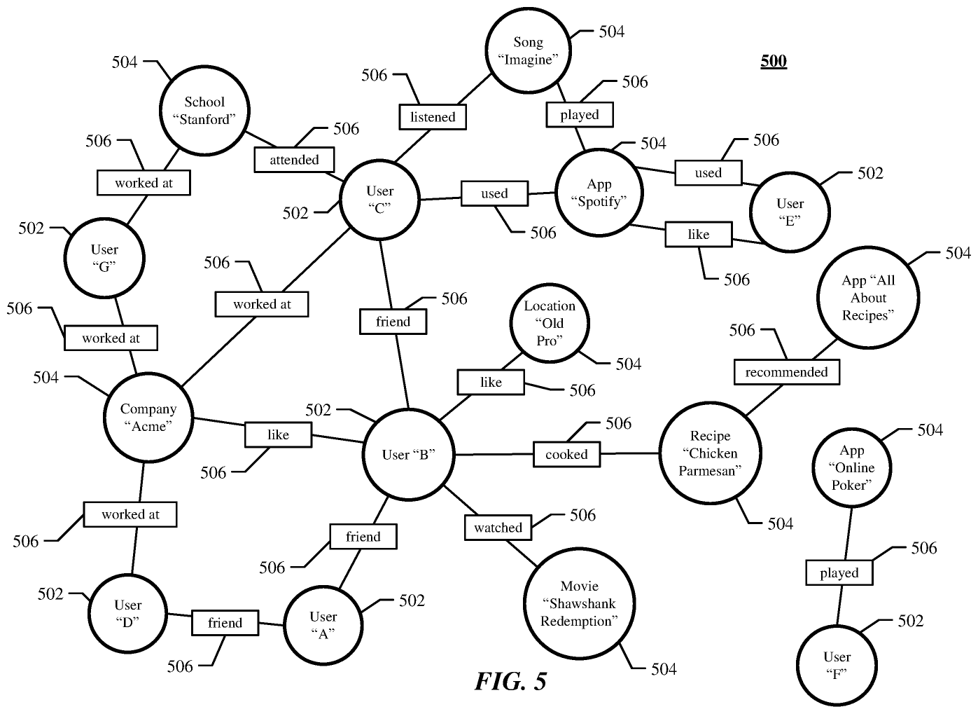

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Each node may be associated with a unique entity (i.e., user or concept), each of which may have a unique identifier (ID), such as a unique number or username. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party system 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506. The degree of separation between two objects represented by two nodes, respectively, is a count of edges in a shortest path connecting the two nodes in the social graph 500. As an example and not by way of limitation, in the social graph 500, the user node 502 of user “C” is connected to the user node 502 of user “A” via multiple paths including, for example, a first path directly passing through the user node 502 of user “B,” a second path passing through the concept node 504 of company “Acme” and the user node 502 of user “D,” and a third path passing through the user nodes 502 and concept nodes 504 representing school “Stanford,” user “G,” company “Acme,” and user “D.” User “C” and user “A” have a degree of separation of two because the shortest path connecting their corresponding nodes (i.e., the first path) includes two edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to an edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, social-networking system 460 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 470 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 460 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 460 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 460 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 460 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 460 may calculate a coefficient based on a user's actions. Social-networking system 460 may monitor such actions on the online social network, on a third-party system 470, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 460 may calculate a coefficient based on the user's actions with particular types of content. The content may be associated with the online social network, a third-party system 470, or another suitable system. The content may include users, profile pages, posts, news stories, headlines, instant messages, chat room conversations, emails, advertisements, pictures, video, music, other suitable objects, or any combination thereof. Social-networking system 460 may analyze a user's actions to determine whether one or more of the actions indicate an affinity for subject matter, content, other users, and so forth. As an example and not by way of limitation, if a user frequently posts content related to “coffee” or variants thereof, social-networking system 460 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 460 may calculate a coefficient based on the type of relationship between particular objects. Referencing the social graph 500, social-networking system 460 may analyze the number and/or type of edges 506 connecting particular user nodes 502 and concept nodes 504 when calculating a coefficient. As an example and not by way of limitation, user nodes 502 that are connected by a spouse-type edge (representing that the two users are married) may be assigned a higher coefficient than a user nodes 502 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 460 may determine that the user has a higher coefficient with respect to the first photo than the second photo because having a tagged-in-type relationship with content may be assigned a higher weight and/or rating than having a like-type relationship with content. In particular embodiments, social-networking system 460 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 460 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 500. As an example and not by way of limitation, social-graph entities that are closer in the social graph 500 (i.e., fewer degrees of separation) may have a higher coefficient than entities that are further apart in the social graph 500.

In particular embodiments, social-networking system 460 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 430 of the user). A first user may be more interested in other users or concepts that are closer to the first user. As an example and not by way of limitation, if a user is one mile from an airport and two miles from a gas station, social-networking system 460 may determine that the user has a higher coefficient for the airport than the gas station based on the proximity of the airport to the user.

In particular embodiments, social-networking system 460 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 460 may provide information that is relevant to user's interests and current circumstances, increasing the likelihood that they will find such information of interest. In particular embodiments, social-networking system 460 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 460 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 460 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 470 (e.g., via an API or other communication channel), or from another suitable system. In response to the request, social-networking system 460 may calculate the coefficient (or access the coefficient information if it has previously been calculated and stored). In particular embodiments, social-networking system 460 may measure an affinity with respect to a particular process. Different processes (both internal and external to the online social network) may request a coefficient for a particular object or set of objects. Social-networking system 460 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

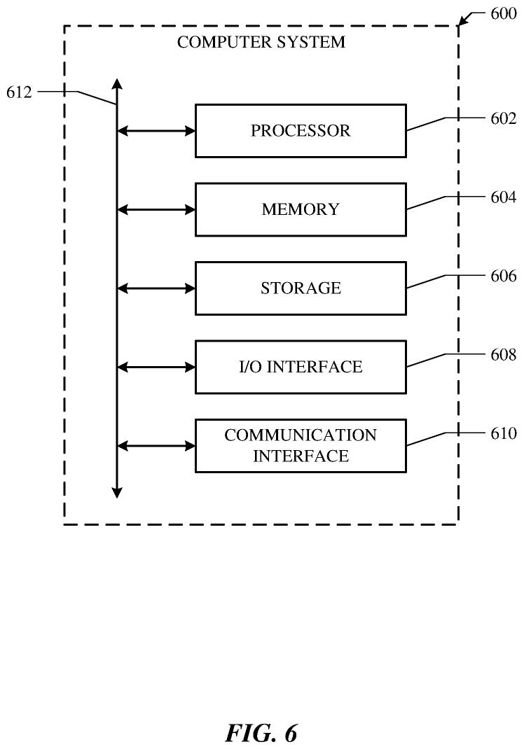

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising:
by a server computing device, streaming digital content for presentation by at least a first user computing device and a second user computing device;
by the server computing device, receiving recorded audio content from the second user computing device;
by the server computing device, determining a ratio for mixing the received recorded audio content from the second user computing device with native audio content from the streamed digital content based on a type of the streamed digital content and a history of user selections for the type of the streamed digital content;
by the server computing device, generating remixed digital content, wherein the remixed digital content comprises content generated by mixing the received recorded audio content with the native audio content from the streamed digital content, wherein the mixing is based on a determined ratio of received recorded audio content to native audio content wherein the determined ratio for mixing comprises a first portion to be allocated to the native audio content from the streamed digital content and a second portion to be allocated to the received recorded audio content from the second user computing device; and
by the server computing device, streaming the remixed digital content for presentation by the first user computing device.

2. The method of claim 1, further comprising a first user and a second user, the first user corresponding to the first user computing device and the second user corresponding to the second user computing device.

3. The method of claim 2, wherein:
the first and second users are users of a social-networking system that comprises a graph that comprises a plurality of nodes and edges connecting the nodes;
one or more nodes in the graph corresponds to the first user;
one or more nodes in the graph corresponds to the second user; and
the second user is of interest to the first user because at least one of the nodes corresponding to the second user and at least one of the nodes corresponding to the first user are connected to each other by an edge.

4. The method of claim 2, wherein the determined ratio of received recorded audio content to native audio content is based on an affinity coefficient between the first user and the second user.

5. The method of claim 1, wherein the determined ratio of received recorded audio content to native audio content is based on user input.

6. The method of claim 1, wherein the server computing device comprises a validator, wherein the validator is configured to synchronize received recorded audio content with native audio content.

7. The method of claim 2, further comprising a first viewing group, wherein the first viewing group comprises a plurality of users and corresponds to a particular piece of digital content, and wherein each user within the first viewing group can hear received recorded audio content from each other user within the first viewing group.

8. The method of claim 3, further comprising a third user, wherein the second user is designated as a primary conversation partner and the third user is designated as a secondary conversation partner, and wherein the determined ratio of received recorded audio content to native audio content further comprises a first sub-ratio of received recorded audio content from the second user to native audio content and a second sub-ratio of received recorded audio content from the third user to native audio content, wherein the first sub-ratio of received recorded audio content from the second user to native audio content is larger than the second sub-ratio of received recorded audio content from the third user to native audio content.

9. One or more computer-readable non-transitory storage media embodying software that is operable when executed to:
stream digital content for presentation by at least a first user computing device and a second user computing device;
receive recorded audio content from the second user computing device;
determine a ratio for mixing the received recorded audio content from the second user computing device with native audio content from the streamed digital content based on a type of the streamed digital content and a history of user selections for the type of the streamed digital content;
generate remixed digital content, wherein the remixed digital content comprises content generated by mixing the received recorded audio content with the native audio content from the streamed digital content, wherein the mixing is based on a determined ratio of received recorded audio content to native audio content, wherein the determined ratio for mixing comprises a first portion to be allocated to the native audio content from the streamed digital content and a second portion to be allocated to the received recorded audio content from the second user computing device; and
stream the remixed digital content for presentation by the first user computing device.

10. The media of claim 9, further comprising a first user and a second user, the first user corresponding to the first user computing device and the second user corresponding to the second user computing device.

11. The media of claim 10, wherein:
the first and second users are users of a social-networking system that comprises a graph that comprises a plurality of nodes and edges connecting the nodes;
one or more nodes in the graph corresponds to the first user;
one or more nodes in the graph corresponds to the second user; and
the second user is of interest to the first user because at least one of the nodes corresponding to the second user and at least one of the nodes corresponding to the first user are connected to each other by an edge.

12. The media of claim 10, wherein the determined ratio of received recorded audio content to native audio content is based on an affinity coefficient between the first user and the second user.

13. The media of claim 9, wherein the determined ratio of received recorded audio content to native audio content is based on user input.

14. The media of claim 9, wherein the server computing device comprises a validator, wherein the validator is configured to synchronize received recorded audio content with native audio content.

15. The media of claim 10, further comprising a first viewing group, wherein the first viewing group comprises a plurality of users and corresponds to a particular piece of digital content, and wherein each user within the first viewing group can hear received recorded audio content from each other user within the first viewing group.

16. The media of claim 11, further comprising a third user, wherein the second user is designated as a primary conversation partner and the third user is designated as a secondary conversation partner, and wherein the determined ratio of received recorded audio content to native audio content further comprises a first sub-ratio of received recorded audio content from the second user to native audio content and a second sub-ratio of received recorded audio content from the third user to native audio content, wherein the first sub-ratio of received recorded audio content from the second user to native audio content is larger than the second sub-ratio of received recorded audio content from the third user to native audio content.

17. A system comprising:
one or more processors; and
one or more computer-readable non-transitory storage media coupled to one or more of the processors and comprising instructions operable when executed by one or more of the processors to cause the system to:
stream digital content for presentation by at least a first user computing device and a second user computing device;
receive recorded audio content from the second user computing device;
determine a ratio for mixing the received recorded audio content from the second user computing device with native audio content from the streamed digital content based on a type of the streamed digital content and a history of user selections for the type of the streamed digital content;
generate remixed digital content, wherein the remixed digital content comprises content generated by mixing the received recorded audio content with the native audio content from the streamed digital content, wherein the mixing is based on a determined ratio of received recorded audio content to native audio content, wherein the determined ratio for mixing comprises a first portion to be allocated to the native audio content from the streamed digital content and a second portion to be allocated to the received recorded audio content from the second user computing device; and
stream the remixed digital content for presentation by the first user computing device.

18. The system of claim 17, further comprising a first user and a second user, the first user corresponding to the first user computing device and the second user corresponding to the second user computing device.

19. The system of claim 18, wherein:
the first and second users are users of a social-networking system that comprises a graph that comprises a plurality of nodes and edges connecting the nodes;
one or more nodes in the graph corresponds to the first user;
one or more nodes in the graph corresponds to the second user; and
the second user is of interest to the first user because at least one of the nodes corresponding to the second user and at least one of the nodes corresponding to the first user are connected to each other by an edge.

20. The system of claim 18, wherein the determined ratio of received recorded audio content to native audio content is based on an affinity coefficient between the first user and the second user.
